(19) United States
(12) Patent Application Publication
(10) Pub. No.: US 2009/0132165 A1
(43) Pub. Date: May 21, 2009

(54) METHOD AND ARRANGEMENT FOR DETERMINING POSITION OF VEHICLES RELATIVE EACH OTHER

(75) Inventors: Bjorn Gabrielsson, Linkoping (SE); Magnus Andersson, Linkoping (SE); Folke Isaksson, Linkoping (SE)

Correspondence Address: VENABLE LLP, P.O. BOX 34385, WASHINGTON, DC, 20043-9998, US

(73) Assignee: SAAB AB, Linkoping (SE)

(21) Appl. No.: 12/261,664

(22) Filed: Oct. 30, 2008

(30) Foreign Application Priority Data
Oct. 30, 2007 (EP) 07119596.0

(51) Int. Cl. G08G 1/00

(52) U.S. Cl. 701/300

(57) ABSTRACT

A relative positioning system, an arrangement, and a method. A method for determining a position of a second vehicle relative to a first vehicle. At least an image of a field of view wherein the second vehicle is positioned within the field of view is recorded using an optical device mounted on the first. Image data is processed in a processor to determine a position of the second vehicle relative the first vehicle measuring at least one marker arranged on the second vehicle in the image.

### FIELD OF THE INVENTION

The invention relates to a method and an arrangement for determining a position of a vehicle. Specifically, the invention relates to determine the position of a vehicle relative another vehicle.

### BACKGROUND OF THE INVENTION

There are a number of different occasions when multiple machines are cooperating during construction or the like, such as when covering roads with asphalt a number of vehicles are cooperating. The result of the work may be based on how the machines move/work relative one another. Taking the asphalt laying process as an example, a main vehicle during the asphalting process is an asphalt layer, that is, the vehicle that provides the asphalt on the surface. The asphalt layer distributes the asphalt with a suitable width and thickness. Behind the asphalt layer is one or a plurality of rollers processing/compacting the asphalt. This compacting process may be performed numerous times, that is, a plurality of compacting rollovers, within a certain amount of time. These parameters, number of rollovers and the time, are also dependent on the weather, the temperature of the asphalt, and the like. The quality of every step of the process influences the final result of the process and consequently how many years the surface will be able to hold. In order to provide a good quality layer the asphalt layer should be moving continuously which may imply that asphalt need to be refilled during the process. An infra red camera may be used to scan the asphalt for temperature variations.

Positioning systems are today rare but the demand for such systems will increase in the future due to a desire of the contractors to commit to a higher degree of quality of the asphalt but also a desire to focus more on the annual cost over the lifetime of the work than the initial cost. The purchasing of a project is today based on area, amount and prescribed prescription of the asphalt, which does not premier the potential of offering higher quality of the asphalt than the quality that today exist.

The systems that today are coming out on the market are based on measuring GPS-systems, wherein GPS equipment is arranged on both rollers as well as on the asphalt layer. General GPS equipment has a precision of 3 to 15 meters and to provide enough precision one would need advanced GPS equipment, such as RTK-GPS equipment or the like, which results in expensive sensors on every participating vehicle. These systems will not work in environments wherein the GPS are disturbed or blocked such as below bridges, in tunnels, tall buildings or trees close to the road, or the like.

Document U.S. Pat. No. 5,646,844 A discloses monitoring and coordination apparatuses, e.g. for earth movers on building site, which shares position information from several machines to generate a common, dynamically updated site database showing positions of machines and site progress in real time using GPS-equipment.

It is desirable to provide a relative cheap and rigid positioning system of cooperating vehicles that will work in an environment wherein the GPS function may be disturbed.

### SUMMARY OF THE INVENTION

In order to achieve an object as stated above the invention relates to a relative positioning system for determining positioning of a second vehicle relative a first vehicle comprising an optical device mounted on the first vehicle and arranged to record an image of an area wherein the second vehicle is positioned, and a processor arranged to process the recorded image, wherein the processor is arranged to process the recorded image so as to determine the position of the second vehicle relative the first vehicle based on measurements in the recorded image of at least one marker arranged on the second vehicle.

In an embodiment the measurements may be length measurements between three markers arranged on the second vehicle.

In addition may each marker be uniquely identifiable in the image and wherein the processor is arranged to determine an orientation of the second vehicle relative the first vehicle based on the positions of the uniquely identifiable markers.

The invention further relates to an arrangement comprising a first vehicle and at least one second vehicle and wherein the first vehicle comprises a relative positioning system according to the above.

In an embodiment the second vehicle is arranged with markers for determination of position and orientation of the first vehicle relative the second vehicle.

In addition, the second vehicle may be arranged with a first marker and a second marker arranged at a predetermined distance in a first plane and a third marker is arranged at a predetermined distance from the first plane.

Furthermore, the first vehicle may further comprise an absolute positioning sensor, such as a GPS-sensor, arranged to determine the absolute position of the first vehicle and wherein the position of the second vehicle relative the first vehicle is used to determine the absolute position of the second vehicle.

In an embodiment is the processor of the first vehicle arranged to store the absolute position of the second vehicle relative the first vehicle in order to document the process quality of a material fed from the first vehicle.

The second vehicle may be a machine vehicle working in cooperation with the first vehicle which may also be a machine vehicle.

In an embodiment the arrangement may comprise a plurality of second vehicles, wherein each second vehicle is provided with a fourth unique marker so as to differentiate the second vehicles from each other.

The invention further relates to a method for determining a position of a second vehicle relative a first vehicle comprising the steps of, recording at least an image of a field of view wherein the second vehicle is positioned within the field of view using an optical device mounted on the first vehicle, and processing image data in a processor to determine position of the second vehicle relative the first vehicle by performing measurements of at least one marker arranged on the second vehicle in the image.

Furthermore, the processing step may further determine an orientation of the second vehicle relative the first vehicle based on the measurements performed on three markers arranged at a predetermined distance relative each other on the second vehicle.

A method for determining the absolute position of a second vehicle, wherein the method comprises the steps of, determining the absolute position of a first vehicle using sensors mounted on the first vehicle; and determining the absolute position of the second vehicle using data from the method for determining the position of the second vehicle relative the first vehicle according to the above and data from the step of determining the absolute position of the first vehicle.

In addition, the invention relates to a method for recording events in a predetermined position comprising the steps of; determining a position of a second vehicle according to a method above, determining each point in time when the second vehicle passes the predetermined position, recording each passage of the predetermined position as an event, and determining the number of events recorded during a predetermined time interval.

In an embodiment the method further comprises a step of determining the predetermined position as the absolute position of the first vehicle at a given point in time using sensors mounted on the first vehicle.

In addition, a time record may be associated to each event.

In an embodiment the first and the second vehicle are machine vehicles cooperating during an asphalting process.

In an embodiment the method is used to form a line ahead formation of the first and the second vehicle.

In an embodiment the first and the second vehicle are unmanned aerial vehicles.

In an embodiment the method is used during refueling of aerial vehicles.

The invention provides a positioning system that can be used in a number of applications, where relative positioning of vehicles is of interest to a low cost.

Furthermore, the positioning shows good availability and accuracy regarding relative positioning of the vehicles independent of the ability to receive absolute positioning.

As in an embodiment of the invention, by documenting how the roller vehicle moves may the quality of the compacting process be documented and this information may also be used, feeding the information back to an operator and a higher quality of the asphalt may be achieved.

### BRIEF DESCRIPTION OF THE DRAWINGS

The invention, together with further objectives and advantages thereof, may best be understood by reference to the following description taken in conjunction with the accompanying drawings in which:

FIG. 1 shows a schematic overview of a positioning systems mounted on a main vehicle according to an embodiment of the invention;

FIG. 2 shows a vehicle in a field of view of an optical sensor arranged on a main vehicle according to an embodiment of the invention;

FIG. 3 shows an embodiment of markers arranged on a vehicle in order to determine distance and/or orientation relative another vehicle according to an embodiment of the invention;

FIG. 4 shows an embodiment of markers arranged on a vehicle defining different distances between the markers;

FIG. 5 discloses a flowchart of a method for determining a position of a vehicle in a field of view of an optical sensor arranged on a main vehicle in accordance with an embodiment of the invention

FIG. 6 shows a flowchart of a method for determining the absolute position of vehicle in a field of view of an optical sensor arranged on a main vehicle in accordance with an embodiment of the invention; and

FIG. 7 shows an overview of two trailing vehicles that are keyed.

### DETAILED DESCRIPTION OF EMBODIMENTS OF THE INVENTION

Referring to FIG. 1, in an embodiment of the invention a robust absolute positioning system 4 is mounted on a main vehicle 10, such as an asphalt layer, comprising integrated sensors 50, such as distance measuring equipment, direction detection equipment and/or the like, equipped with different characteristics, and an optical equipment 30, such as cameras or the like, fixated on the main vehicle 10, and a processor 60 for determining position of a vehicle 20 in the field of view of the optical equipment relative the main vehicle. The processor 60 and the optical equipment 30 constitute a relative positioning system 2, marked with a dashed line.

In the embodiment the robust absolute positioning system 4 of the main vehicle is arranged on the main vehicle 10 and further comprises software for the integrated sensor/s, and an absolute positioning system 40 with a reduced availability, for example, Global Navigation Satellite System (GNSS), radio navigation system or the like, and inertial sensors 50 with high availability, such as Gyros, velocity, acceleration sensors or the like. When the absolute positioning system 40 drops/fails the inertial sensors 50 will aid the navigation software arranged in a processor 60 with information in order to calculate, not connected to the positioning system, the position of the main vehicle 10 in a system of coordinates. The inertial sensors 50 may be a gyro providing direction information and a velocity sensor in order to calculate the position. It should be noted that the absolute positioning system is optional.

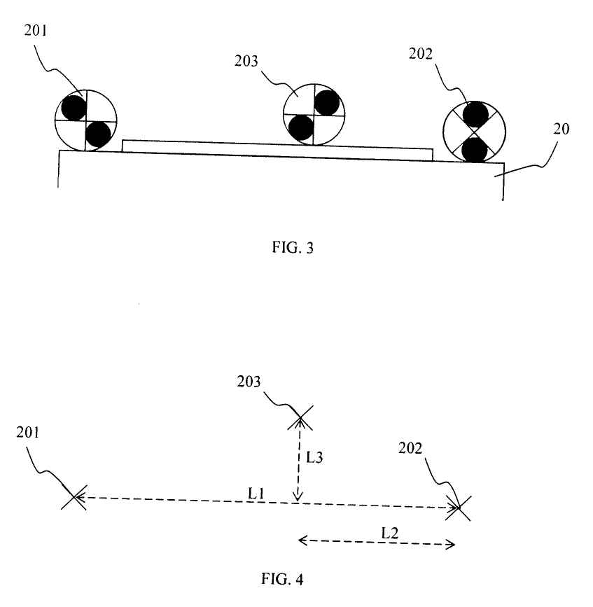

The relative positioning system 2 is mounted on the main vehicle 10 and comprises optical equipment 30, for example, cameras or the like, and software that calculates position of each vehicle being in the field of view of the optical equipment, arranged on a processor 60. The vehicle 20 is equipped with indication markers or the like mounted on the rollers. An example is disclosed in FIG. 3. The software may further determine orientation, velocity, or the like of the vehicle in sight.

There are a number of possible arrangements to aid the determination of the position and, if desired, direction of the vehicle in sight, such as, markers mounted on rollers; lightning arranged on the main vehicle and reflexes mounted on the vehicle in sight, light sources mounted on the vehicle/s in sight, three dimensional modelling of the vehicle in sight in software and correlation calculations, and the like.

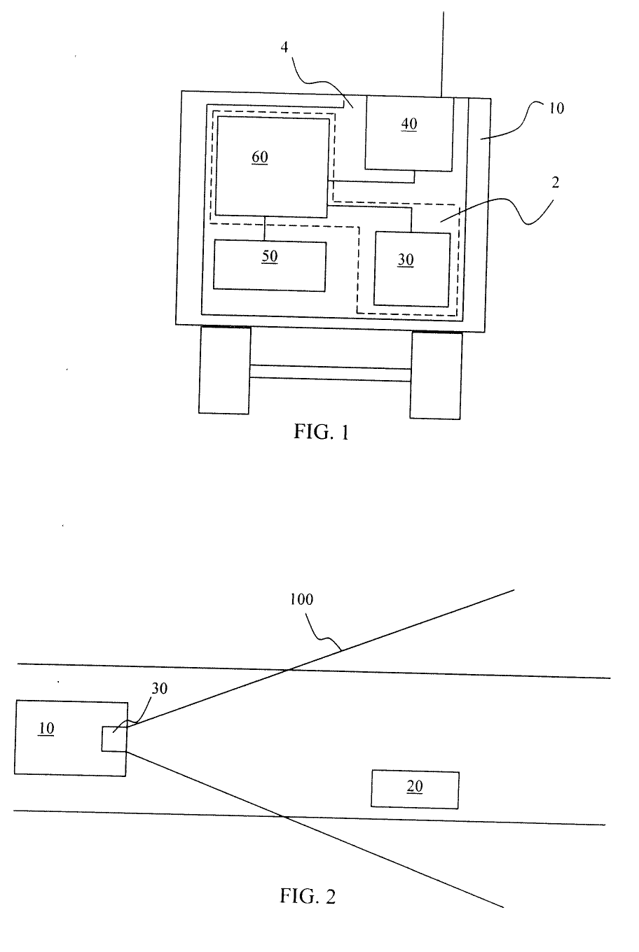

FIG. 2 shows an overview of an embodiment of the invention during an asphalt laying process. The asphalt cools off rather quickly during the asphalting process and the asphalt layer 10 moves rather slowly. Thus, the main compacting area of the asphalt of interest of is generally the area approximately 70 meters behind the asphalt layer 10. A positioning and orientating system onboard the asphalt layer 10 calculates the position and the orientation for one or more cameras. One or more cameras 30 of the positioning system records images in order to determine the distance and direction to a roller 20 within a field of view 100 of the optical equipment.

FIG. 3 shows an embodiment of the invention the vehicle 20, such as a roller, is provided with at least three markers 201, 202, 203 in order to facilitate the determination of position relative a main vehicle during image processing. A first marker 201 is mounted parallel to a second marker 202 and a third marker 203 is mounted in between but displaced backwardly. The markers are thereby extending sideways as well as lengthwise, as in the example two parallel markers sideways mounted and a marker placed in between at a distance from the line between the first and the second marker. The markers are mounted at predetermined places on the vehicle. By knowing the distance between the first 201 and second marker 202 one may determine the distance to the vehicle in sight by the distance between the first 201 and second marker 202 in the image. However, if the vehicle in sight may have a heading not straight towards the optical sensor, the system also needs to determine the orientation of the vehicle in sight in order to determine the relative position. This is done by positioning the third marker 203 at a distance from the plane in which the first and the second marker is positioned. The distances between the three markers are then used in order to determine the relative position of the trailing vehicle to the main vehicle.

In the illustrated embodiment the markers are identified by different patterns, such as the black rings on the markers are differently positioned. As stated, by identifying the marker placed backwardly relative the positions of the two front markers the orientation of the roller may be determined. When this orientation is determined the sideways distance between the markers is used to determine the distance between the main vehicle and the vehicle in sight. In an embodiment the markers are not differentiated in design since the cooperating vehicle in sight is always moving with the front facing the asphalt layer, thereby resulting in that the image processing system will always know the identity of the markers 201-203, always being positioned and uniquely identified in the image as a left, middle and right marker.

It should be noted in the embodiment of the black and white fields of the different markers, the markers may be differentiated by merely turning the patterns of the markers an angle to differentiate the markers from each other.

The position and orientation may also be used when the vehicle in sight is a roller vehicle that is provided with a plurality of roller drums mounted, for example, back and front on the roller vehicle. In this type of embodiment the front roller drum may be displaced sideways by providing an articulation point at the centre of the roller vehicle. The back drum is merely marked up with a marker, whereas in order to achieve the same result using GPS system additional GPS equipment has to be used mounted positioning the back roller drum.

FIG. 4 discloses generally known parameters used in order to determine a distance to a roller vehicle. A set distance L1 between the first marker 201 and the second marker 202 is used in the determination process. However, in order to determine the distance to the roller vehicle from the asphalt layer when the roller is orientated at an angle to the camera direction, the third marker 203 is provided at set distances L2 and L3. Distance L2 defining the distance the thirds marker 203 is located along the line between marker 201 and marker 202, L3 defining the distance the third marker 203 is located behind the line between marker 201 and marker 202. Thereby, the distance to the roller may be calculated based on the recorded distances between the markers 201-203 and the known distances L1-L3.

It should be understood that a marker may be of any kind such as, prism, infra red diode, any visual marker, or the like.

In an embodiment the direction in the absolute system is determined from the image since it is fixedly mounted in a calibrated direction relative the navigation system of the main vehicle. In this embodiment the main vehicle is positioned in an absolute positioning system, for example, GPS or the like, and the vehicles in sight will also be able to be positioned in this system due to the relative positioning process.

One advantage of this type of system is that all sensors are mounted on one vehicle/machine. The relative positioning system will also function when the satellite signal is blocked positioning vehicles in sight of the optical equipment in the absolute system. In the embodiment wherein an integrated navigation system is mounted on an asphalt layer the availability of the system is high. The integrated navigations system may be gyro, accelerometers, inclinometers, barometers, altimeters, mechanical distance wheel, or non-contact distance camera, and/or other distance and direction sensitive means. In an absolute positioning system the coordinates of an area that has been missed is easily presented to a roller vehicle in order to correct and process the missed area.

The optical means to record the image of the vehicle in sight may be performed by a single camera or a plurality of cameras such as a close up camera and a camera used at longer distances with, for example, different resolutions. Different types of cameras may be used, such as, analogue, fire wire, IP cameras, USB, or the like.

The positioning system may be embodied merely calculating the distance to the vehicle in sight. However, by adding the orientation the result is more accurate and the result is more satisfying.

The data from the mounted image recording means is processed locally at the asphalt layer.

The system may document that the compacting process has been preformed a number of times during a certain time and is used when determining the quality of the asphalt process. In an example of the presentation of an asphalting process a computer program may present the asphalt process and the number of times an area has been rolled over by a roller by indicating the area in different colours indicating the number of times.

In an embodiment the resulting data such as number of times as well as positioning data of the roller may be presented to the vehicle in the field of view of the optical equipment. The feedback data may be used to inform the operator of the vehicle in the field of view of the camera equipment where areas been missed/clear, that the vehicle is in a right position, and/or the like. The feedback data may be transferred by using a radio data link, such as WLAN or the like. It should also be noted that the information may be used to control vehicles in the field of view in an automated system wherein the vehicle is unmanned.

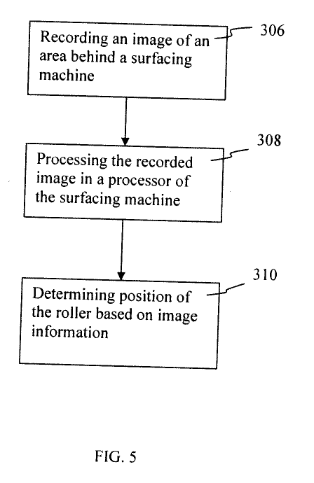

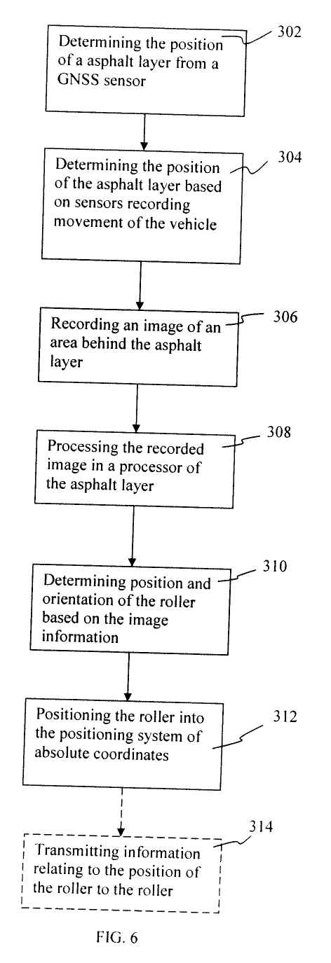

FIG. 5 discloses a method of determining a position of a vehicle relative another vehicle, wherein the method is embodied in a configuration comprising a main vehicle, such as a surfacing machine, and a trailing working machine, such as a roller.

In step 306 an image recording arrangement, such as a camera or the like, records an image of an area behind the surfacing machine. It should be understood that the camera in a different embodiment may be mounted on a vehicle recording an image of an area ahead of the vehicle. It should also be understood that the number of optical sensors may vary in order to increase the field of view or to improve the resolution of the images. It should also be understood that the recording apparatus may record still images, moving images, temperature images and/or the like and any combination thereof.

In step 308 the recorded image is transferred to a processor arranged in an electrical system of the surfacing machine, such as an asphalt layer, and the image is processed in the processor resulting in a number of positioning parameters, such as number of pixels, horizontally and vertically, between markers arranged on the roller for example as described in FIGS. 3 and 4.

In step 310 the parameters from the image processing are used in determining the position of the roller within the field of view relative the surfacing machine. In an embodiment the orientation of the roller is also determined. The camera is to be calibrated with the lens system, wherein a number of parameters are determined. This enables the possibility of precise calculations.

In FIG. 6 an embodiment is disclosed showing a method of determining the absolute position of a trailing cooperating vehicle, such as a roller, in a system of absolute coordinates when positioning signals from an absolute positioning system are disturbed or interrupted, such as in a tunnel or the like.

In step 302 the absolute position of a main vehicle, such as an asphalt layer, working in an environment wherein no interference/obstruction of GNSS signals exist, is continuously determined via a GNSS sensor, such as a GPS sensor, mounted on the asphalt layer. It should here be noted that any type of satellite positioning system may be used and the positioning sensor may be mounted at various places on the machine.

However, when the asphalt layer moves into a tunnel or the like the connection to the GPS system or the like is interrupted. In step 304 the positioning system of the machine uses the readings from distance sensors, such as a distance wheel, a non-contact velocity sensor or the like, determining the distance the machine has traveled since connection to the GPS system was interrupted and direction sensors such as Gyros, determining the direction of the machine. These readings are used to determine the position of the asphalt layer in the tunnel during operation of the vehicle.

In step 306 an optical sensor record an image of the field of view of the optical equipment.

In step 308 the recorded image is transferred to a processor arranged in an electrical system of the main vehicle, in the example, the asphalt layer, and the image is processed in the processor resulting in a number of positioning parameters, such as number of pixels, horizontally and vertically, between markers arranged on the roller for example as described in FIGS. 3 and 4.

In step 310 the parameters from the image processing are used in determining the position of the roller within the field of view relative the asphalt layer. The parameters may also be used in order to determine the orientation of the roller. The camera is to be calibrated with the lens system, wherein a number of parameters are determined, such as a relationship between a certain pixel to a certain angle to the object. This enables the possibility for using the image for precise calculations.

In step 312 the determined position is in conjunction with the absolute positioning data in the absolute system of coordinates, determined from the GPS and inertial sensors at step 302, used to determine position of the vehicle in the field of view of the optical sensor in the absolute system of coordinates. It should be noted that the system may also position a plurality of rollers within the field of view, wherein the markers of the different vehicles may be differentiated by different patterns or the like.

In FIG. 6 an optional additional step is disclosed with dashed lines. The step 314 is performed when the determined position is used to control or inform an operator/or the control system of the vehicle the position of itself. This additional step may also be added in an arrangement using merely the relative positioning system. In step 314 the position information is transmitted to the roller.

The present solution provides a way of determining the position of vehicles, such as rollers or the like, relative a main vehicle that is cheap and reliable. The system requires merely an optical sensor mounted on the main vehicle and software determining positioning parameters of the vehicles within the field of view of the optical sensor. In an embodiment the vehicles are provided with markers in order to establish positioning parameters. The invention provides a solution wherein the number of positioning sensors is reduced.

It should also be understood that the relative positioning system may be mounted on a vehicle positioned rear of a main vehicle displaying the relative positioning information to the operator of the vehicle and may also be used in order to transmit the information to the main vehicle. Additionally, the vehicle moving behind the main vehicle may comprise an absolute positioning system.

The relative positioning system may position/orientate a number of working machines, such as rollers or other working machines, wherein the rollers have markers that are keyed in a way that makes it possible to differentiate the different vehicles.

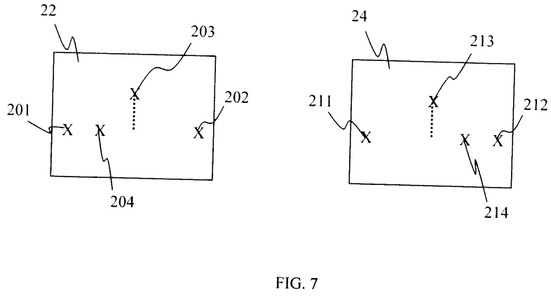

FIG. 7 discloses a schematic top view of two different vehicles trailing a main vehicle. A first vehicle 22 comprises four markers 201-204 and a second vehicle 24 comprises four markers 211-214. The fourth marker 204, 214 of each vehicle is called a key marker and it is these markers that distinguish the first vehicle from the second vehicle in an embodiment of the positioning system. It should be noted that in the illustrated embodiment the distances between the first vehicle's markers 201-203 and the second vehicle's markers 211-213 are the same for each vehicle in order to facilitate the calculation. The key marker 204, 214 may be marked with different patterns or the like.

The system may also be used for vehicles travelling in a line ahead formation, air fuelling of an aircraft or the like.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

1. A relative positioning system for determining positioning of a second vehicle relative to a first vehicle, the relative positioning system comprising:
at least one marker arranged on the second vehicle,
an optical device mounted on the first vehicle and arranged to record an image of an area where the second vehicle is positioned, and
a processor arranged to process the recorded image, wherein the processor is arranged to process the recorded image so as to determine the position of the second vehicle relative the first vehicle based on measurements in the recorded image of the at least one marker arranged on the second vehicle.

2. The relative positioning system according to claim 1, wherein the measurements are length measurements between three markers arranged on the second vehicle.

3. The relative positioning system according to claim 2, wherein each marker is uniquely identifiable in the recorded image and wherein the processor is arranged to determine an orientation of the second vehicle relative the first vehicle based on the positions of the uniquely identifiable markers.

4. An arrangements comprising:
a first vehicle
at least one second vehicle, and
a relative positioning system comprising at least one marker arranged on the second vehicle, an optical device mounted on the first vehicle and arranged to record an image of an area where the second vehicle is positioned, and a processor arranged to process the recorded image wherein the processor is arranged to process the recorded image so as to determine the position of the second vehicle relative the first vehicle based on measurements in the recorded image of the at least one marker arranged on the second vehicle.

5. The arrangement according to claim 4, wherein a plurality of markers are arranged on the second vehicle for determination of position and orientation of the first vehicle relative to the second vehicle.

6. The arrangement according to claim 5, wherein a first marker and a second marker are arranged on the second vehicle at a predetermined distance in a first plane, and wherein a third marker is arranged on the second vehicle at a predetermined distance from the first plane.

7. The arrangement according to claim 4, wherein the first vehicle further comprises an absolute positioning sensor arranged to determine an absolute position of the first vehicle and wherein the position of the second vehicle relative to the first vehicle is used to determine an absolute position of the second vehicle.

8. The arrangement according to claim 7, wherein the processor of the first vehicle is arranged to store the absolute position of the second vehicle relative the first vehicle in order to document a process quality of a material fed from the first vehicle.

9. The arrangement according to claim 4, wherein the second vehicle is a machine vehicle working in cooperation with the first vehicle which is also a machine vehicle.

10. The arrangement according to, claim 4, wherein the arrangement comprises a plurality of second vehicles, and wherein each second vehicle comprises a fourth unique marker so as to differentiate the second vehicles from each other.

11. A method for determining a position of a second vehicle relative a first vehicle, the method comprising:
recording at least an image of a field of view wherein the second vehicle is positioned within the field of view using an optical device mounted on the first vehicle, and
processing image data in a processor to determine position of the second vehicle relative the first vehicle by performing measurements of at least one marker arranged on the second vehicle in the image.

12. The method according to claim 11, wherein the processing further determines an orientation of the second vehicle relative the first vehicle based on the measurements performed on three markers arranged at a predetermined distance relative each other on the second vehicle.

13. A method for determining an absolute position of a second vehicle, the method comprising:
determining the absolute position of a first vehicle using sensors mounted on the first vehicle; and
determining the absolute position of the second vehicle using data from the absolute positioning and data from a method for determining the position of the second vehicle relative the first vehicle comprising recording at least an image of a field of view wherein the second vehicle is positioned within the field of view using an optical device mounted on the first vehicle, and processing image data in a processor to determine position of the second vehicle relative the first vehicle by performing measurements of at least one marker arranged on the second vehicle in the image.

14. A method for recording events in a predetermined position, the method comprising:
determining a position of a second vehicle according to a method comprising recording at least an image of a field of view wherein the second vehicle is positioned within the field of view using an optical device mounted on the first vehicle, and processing image data in a processor to determine position of the second vehicle relative the first vehicle by performing measurements of at least one marker arranged on the second vehicle in the image,
determining each point in time when the second vehicle passes the predetermined position,
recording each passage of the predetermined position as an event, and
determining a number of events recorded during a predetermined time interval.

15. The method according to claim 14, further comprising:
determining the predetermined position as an absolute position of the first vehicle at a given point in time using sensors mounted on the first vehicle.

16. The method according to claim 14, further comprising:
associating a time record to each event.

17. The method according to claim 11, wherein the first vehicle and the second vehicle are machine vehicles cooperating during an asphalting process.

18. The method according to claim 11, further comprising:
utilizing the method to form a line ahead formation of the first and the second vehicle.

19. The method according to claim 11, wherein the first vehicle and the second vehicle are unmanned aerial vehicles.

20. The method according to claim 11, further comprising:
utilizing the method during refueling of aerial vehicles.
